(19) United States
(12) Patent Application Publication
(10) Pub. No.: US 2012/0250610 A1
(43) Pub. Date: Oct. 4, 2012

(54) METHOD FOR CONTROLLING RADIO-SILENCE IN WIRELESS DEVICES

(75) Inventors: Ramakrishna Budampati, Maple Grove, MN (US); Joseph Citrano, III, Eden Prairie, MN (US)

(73) Assignee: HONEYWELL INTERNATIONAL INC., Morristown, NJ (US)

(21) Appl. No.: 13/075,566

(22) Filed: Mar. 30, 2011

(51) Int. Cl. H04W 4/00

(52) U.S. Cl. 370/328

(57) ABSTRACT

The techniques of this disclosure allow a central wireless monitoring device, such as a coordinator device, in a wireless network to remotely control the operation of wireless end devices in the network. In particular, controlling the operation of the wireless end devices may include enabling and disabling different modes of operation, such as a radio silence mode, of the devices. The monitoring device may wirelessly transmit a command that turns devices, which in normal operation transmit and receive data, into receiving-only devices. The end devices may operate in the receiving-only mode until the monitoring device sends a command that restores the normal operating mode of transmitting and receiving data.

### TECHNICAL FIELD

This disclosure relates to networks, and more particularly to wireless networks.

### BACKGROUND

Wireless networks are used in a variety of applications, and the specific protocol used to set up a wireless network may depend on the purpose of the network, the range the network needs to cover, and the power consumption requirements. ZigBee is a wireless network specification based on the IEEE 802.15.4 standard. ZigBee networks are used in low-power applications such as wireless light switches, in-home displays, consumer electronics, and the like. ZigBee networks are generally low-rate wireless personal area networks (PANs) that are simpler and less expensive to operate than other types of PANs. ZigBee networks are usually targeted at radio frequency applications that require a low data rate, long battery life, and secure networking.

### SUMMARY

In general, the disclosure describes techniques for remotely controlling operation of devices in a wireless network. Specifically, this disclosure describes techniques for changing the mode of operation of devices in a wireless network to and from radio silence mode. Small or personal area networks, such as those based on the ZigBee standard or IEEE 802.15.4 standard, may be used to remotely control operation of devices with limited power supply or battery life. Therefore, turning off the devices of the network during certain times may prolong the battery life of the devices. Additionally, in certain circumstances or environments, it may be necessary to send the devices into a radio silence mode to prevent accidents.

The techniques of this disclosure allow a central wireless monitoring device, such as a coordinator device, in a wireless network to remotely or wirelessly control the operation of end devices in the wireless network. In particular, controlling the operation of the devices may include enabling and disabling different modes of operation, such as a radio silence mode, of the devices. The central monitoring device may wirelessly send a disabling command that turns devices, which in normal operation mode transmit and receive data, into receiving-only devices. The devices may operate in the receiving-only mode until the central monitoring device sends an enabling command that restores the normal operating mode of transmitting and receiving data in the end devices.

In one example, the disclosure is directed to a method comprising receiving, by a wireless monitoring device associated with a wireless network comprising one or more wireless end devices, a first command to disable the one or more wireless end devices, transmitting to the one or more wireless end devices a disabling command signal, wherein each of the one or more wireless end devices is caused to operate in a disabled end device mode upon receiving the disabling command signal, and wherein during the disabled end device mode each of the one or more wireless end devices shuts off and periodically turns on a receive-only mode to determine if there are any signals have been transmitted to it by other devices in the wireless network, and activating a disabled monitoring device mode in the wireless monitoring device upon confirmation that each of the one or more wireless end devices is disabled.

In another example, the disclosure is directed to a method comprising receiving, by a wireless monitoring device associated with a wireless network comprising one or more wireless end devices, a first command to disable the one or more wireless end devices, transmitting to the one or more wireless end devices a disabling command signal, wherein each of the one or more wireless end devices is caused to operate in a disabled end device mode upon receiving the disabling command signal, and activating a disabled monitoring device mode in the wireless monitoring device upon confirmation that each of the one or more wireless end devices is disabled.

In another example, the disclosure is directed to a wireless monitoring device associated with a wireless network comprising a processor to receive a first command to disable one or more wireless end devices, wherein the wireless network comprises the one or more wireless end devices; and a transceiver to transmit to the one or more wireless end devices a disabling command signal, wherein each of the one or more wireless end devices goes into a disabled end device mode upon receiving the disabling command signal, and wherein the processor activates a disabled monitoring device mode in the wireless monitoring device upon confirmation that each of the one or more wireless end devices is disabled.

In another example, the disclosure is directed to a computer-readable storage medium comprising instructions that, when executed, cause a processor of a wireless monitoring device to receive a first command to disable one or more wireless end devices, wherein the wireless monitoring device is associated with a wireless network comprising the one or more wireless end devices, transmit to the one or more wireless end devices a disabling command signal, wherein each of the one or more wireless end devices goes into a disabled end device mode upon receiving the disabling command signal, and activate the disabled monitoring device mode in the wireless monitoring device upon confirmation that each of the one or more wireless end devices is disabled.

The details of one or more implementations are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example wireless network that can implement techniques of this disclosure.

FIGS. 2 is a block diagram illustrating an example wireless network in accordance with techniques of this disclosure

FIG. 3A illustrates an example timeline of operation of monitoring device and end device during normal operation mode.

FIG. 3B illustrates an example timeline of operation of monitoring device and end device while changing from normal operating mode to radio silence mode.

FIG. 3C illustrates an example timeline of operation of monitoring device and end device during radio silence mode.

FIG. 3D illustrates an example timeline of operation of monitoring device and end device while returning from radio silence mode to normal operating mode.

FIG. 4A is a flow chart of an example method for disabling devices in a wireless network, in accordance with techniques of this disclosure.

FIG. 4B is a flow chart of an example method for enabling devices in a wireless network, in accordance with techniques of this disclosure.

### DETAILED DESCRIPTION

In general, the disclosure describes techniques for remotely controlling operation of wireless end devices in a wireless network. Specifically, this disclosure describes techniques for changing the mode of operation of end devices in a wireless network to and from radio silence mode. Small or personal area networks, such as those based on the ZigBee standard or IEEE 802.15.4 standard, may be used to remotely control operation of wireless end devices with limited power supply or battery life. Therefore, turning off the end devices of the network during certain times may prolong the battery life of the end devices. Additionally, in certain circumstances or environments, it may be necessary to send the devices into a radio silence mode, e.g., to prevent accidents. For example, in an environment such as a blasting zone, the blasting may be done remotely using wireless equipment, and if other devices are operating, interfering signals may affect the operation of the equipment, and subsequently affecting the blasting operations. While devices are in a normal operating mode, the devices transceivers may be transmitting and receiving signals, which can interfere with other wireless signals in a surrounding environment, therefore, affecting the operation of other devices.

Some wireless networks, such as those based on the ZigBee standard, may offer low-cost and low-power wireless network options that can be used in applications that require low data rates and low power consumption. For example, ZigBee wireless networks may be used in industrial control, medical data collection, smoke and intruder warning, building/home automation, and the like. Specific examples may include home entertainment and control such as, smart lighting, temperature control, security devices, entertainment systems, and so forth. Another example where personal area networks may be used is to control switches and sensors in remote or hazardous areas like mines and refineries, for example.

In some examples, a user of the wireless network may wish to control the operating mode of the devices in the wireless network. For example, a user may wish to disable all devices in the wireless network to perform maintenance, to prolong battery life associated with the devices, or to avoid accidents during certain hazardous conditions. Manually disabling each of the devices may be cumbersome and inconvenient and may require more time than allowed by the conditions requiring turning the devices on and off. Additionally, a user may inadvertently overlook one of the devices if the user has to manually disable each of the devices. The same issues may arise when the user wishes to re-enable the devices. Furthermore, manually disabling devices or removing their power sources (e.g., batteries) may not be an option if the devices are not easily accessible.

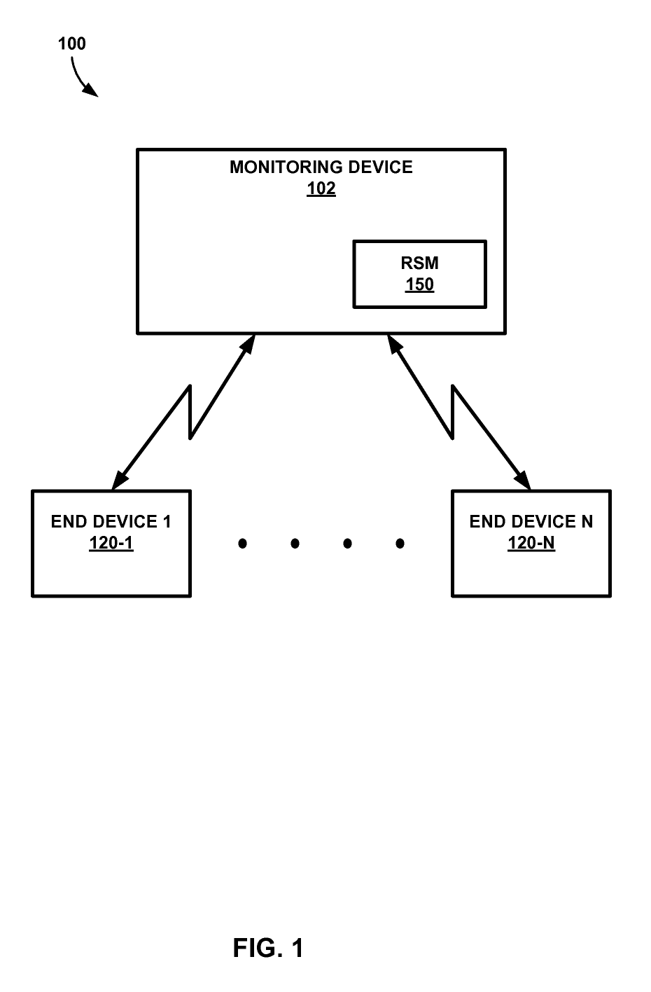

FIG. 1 is a block diagram illustrating an example wireless network 100 that can implement the techniques of this disclosure. Network 100 may be a small or personal wireless network, for example, a ZigBee network based on the IEEE 802.15.4 standard. Network 100 may include one or more wireless network devices, including wireless monitoring device 102 and one or more wireless end devices 120-1 to 120-N (referred to collectively as end device(s) 120). In the example of a ZigBee network, monitoring device 102 is a wireless coordinator device, which forms the root of wireless network 100 and is the device that is used to set up the wireless network, and communicate with and control operations associated with end devices 120.

Among other functionalities, monitoring device 102 may be responsible for communicating data and commands to end devices 120. Monitoring device 102 may receive commands from a user, which monitoring device 102 may then translate to commands to one or more end devices 120. The commands that monitoring device 102 receives form the user may be direct (e.g., the user activates a switch coupled to monitoring device 102) or indirect (e.g., the user configures in monitoring device 102 setting associated with certain events and conditions). Monitoring device 102 may wirelessly receive data from end devices 120, which monitoring device 102 may then translate to an output to a user indicating the data received from end devices 120 (e.g., a blinking light, a sound, an output on a user interface, and the like). Typically, during normal operation, end device 120 may operate in a mode where end device 120 transmits and receives data to and from monitoring device 102.

In some examples, small or personal wireless networks, such as wireless network 100 of FIG. 1, may be set up to control operations of devices for applications that require low data rate and power consumption. For example, wireless network 100 may be set up in a building or home to control operation of devices such as lights, sensors of alarm systems, and the like. In another example, wireless network 100 may be implemented in environments where hazardous conditions may exist, to control operation of devices such as lights, sensors responsive to particular stimulus (e.g., temperature, light level, etc.), and the like.

In some examples, certain conditions may require that end devices operate in a mode other than the normal operating mode or be disabled for a specific period of time. For example, in environments such as mines and refineries, during certain times such as during blasting or other hazardous situations, it may be necessary to disable wireless devices as an additional safety measure, e.g., to prevent signal interference with signals controlling operations associated with the environment. However, trying to physically disable or change an operating mode of an end device may not be feasible or efficient. For example, there may be an immediate need to disable all end devices in a network. Likewise, when it is time to re-enable the end devices, there may be an immediate need to re-enable the normal operations of the end devices. In some instances, there may be too many end devices and the end devices may be located at several locations, thus time constraints may exist to allow a user to disable then enable each of the devices in a network. Additionally, the end devices may be located in remote locations and not easily accessible for a user to change the end devices' operating mode, or disable and enable them.

In one example, monitoring device 102 may include several components including radio silence module 150. Monitoring device 102 may utilize radio silence module 150 to remotely disable end devices 120 by sending them into radio silence mode, and may also utilize radio silence module 150 to remotely enable end devices 120 operating in radio silence mode back to operating in normal mode according to techniques of this disclosure, as described below in more detail.

As discussed in this disclosure, when a wireless device (e.g., end device 120) operates in a disabled end device mode (e.g., radio silence mode), the device stops transmitting and operates in a receive-only manner. Operators of radio devices, or devices capable of transmitting and receiving signals over radio waves, may utilize radio silence for safety and/or security reasons. In one example, as noted above, devices operating in hazardous areas (e.g., mines, refineries, and the like) may operate in radio silence mode during periods when hazardous conditions are heightened such as, during blasting. In other examples, radio silence may be utilized in military applications, where devices in a military zone may be switched into radio silence mode during heightened security times, such that signals transmitted from devices are not intercepted and used to reveal troop locations.

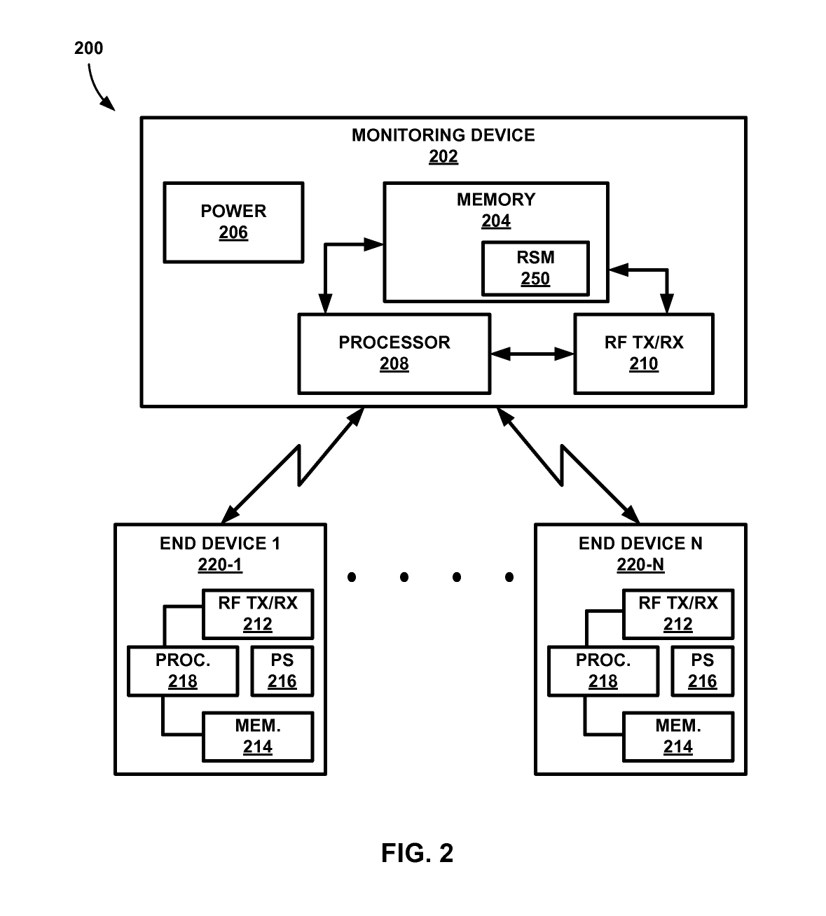

FIG. 2 is a block diagram illustrating an example wireless network 200 in accordance with techniques of this disclosure. Network 200 may be a small or personal area network and may include wireless monitoring device 202 (e.g., a ZigBee network coordinator) and one or more wireless end devices 220-1 to 220-N (referred to as end device(s) 220). Monitoring device 202 may include memory 204, power source 206, processor 208, and radio frequency (RF) transceiver 210. Coordinator 202 may be similar to coordinators 102 of FIG. 1. Each of end devices 220 may include RF transceiver 212, memory 214, power source 216, and processor 218. Each of transceivers 210 and 212 may comprise a transmitter and a receiver, and may be capable of operating in a mode where both the transmitter and receiver are enabled, or where one or both of the transmitter and receiver are disabled.

Each of memory 204 and memory 214 may include one or more computer-readable storage media. Each of memory 204 and memory 214 may comprise one or more storage devices, capable or long-term and short-term storage of information. Short-term storage of each of memory 204 and memory 214 may also be described as a volatile memory. Examples of volatile memories include random access memories (RAM), dynamic random access memories (DRAM), synchronous dynamic random access memory (SDRAM), static random access memories (SRAM), and other forms of known volatile memories. Long-term storage of each of memory 204 and memory 214 may also be described as non-volatile memory. Examples of such non-volatile storage elements may include magnetic hard discs, optical discs, floppy discs, flash memories, or forms of electrically programmable memories (EPROM) or electrically erasable and programmable (EEPROM) memories.

In one example, memory 204 may be used to store program instructions for execution by processor 208 such as, for example, radio silence module 250. Memory 204 may be also used by software or applications running on monitoring device 202 to temporarily store information during program execution.

In one example, memory 214 may be used to store program instructions associated with the operation of end device 220. Memory 214 may be the minimum amount of memory needed for the operation of end device 220, to maintain as low a level of power consumption as possible.

Processor 208 may execute one or more algorithms and instructions such as, for example, those associated with radio silence module 250. Processor 208 may also process data transmitted and received via transceiver 210. Additionally, processor 208 may interpret input from a user or certain environment conditions to determine the appropriate mode of operation of end devices 220 and process the appropriate command signals to be sent by the RF transceiver accordingly.

Processor 218 may execute instructions such as, for example, those associated with the operation of end device 220, e.g., turning a light on or off, sensing a certain condition, or the like. Additionally, processor 218 may process command signals and data received from monitoring device 202 and data transmitted to monitoring device 202. Processor 218 may require low power to execute a minimum amount of instructions needed to operate end device 220.

Monitoring device 202 may be the central device of wireless network 200. A user may utilize monitoring device 202 to set up network 200 and coordinate the operations of one or more wireless end devices 220 associated with network 200. For example, monitoring device 202 may send command signals to end devices 220 to perform a certain operation associated with the corresponding end device 220 such as, for example, turning a light on or off, sensing a certain condition associated with the end device, and the like. In some examples, monitoring device 202 may receive instructions from a user to perform a certain operation or to obtain certain information from one or more end devices 220.

According to the techniques of this disclosure, monitoring device 202 may be configured to control the operating mode of end devices 220. In one example, the operating mode of end devices 220 may include normal operating mode and disabled end device mode (e.g., radio silence mode). During normal operating mode, end devices 220 may operate in transmit and receive modes, where the transmitting and receiving capabilities are both enabled in transceiver 212. During normal operation, end device 220 may operate according to certain instructions based on the type of device it is and the command signals of monitoring device 202 with instructions for end devices 220. As part of its operation, end device 220 may be required to sense a condition or perform an operations associated with its functionality at specified intervals or when a certain condition arises, e.g., sense amount of light, capture a photo, turn on/off a light, and so forth.

End device 220 may activate a sleep mode during its normal operation to consume less power and prolong battery life. In one example, normal operation may involve having transceiver 212 operating to transmit and receive signals from other devices in network 200, and sleep mode may involve turning off transceiver 212 or turning off the transmitter portion of transceiver 212. End device 220 resume normal operation and terminate sleep mode to perform an operation, and transmit data to monitoring device 202 regarding the performed operation, e.g., the sensed data, the captured photo, and so forth. End device 220 may then receive a signal from monitoring device 202 acknowledging receipt of the transmitted data. Upon receiving the acknowledge signal, end device 220 may resume sleep mode until the next time end device 220 has to transmit data to monitoring device 202. In one example, monitoring device 202 may also send data to the user indicating the data received from end device 220.

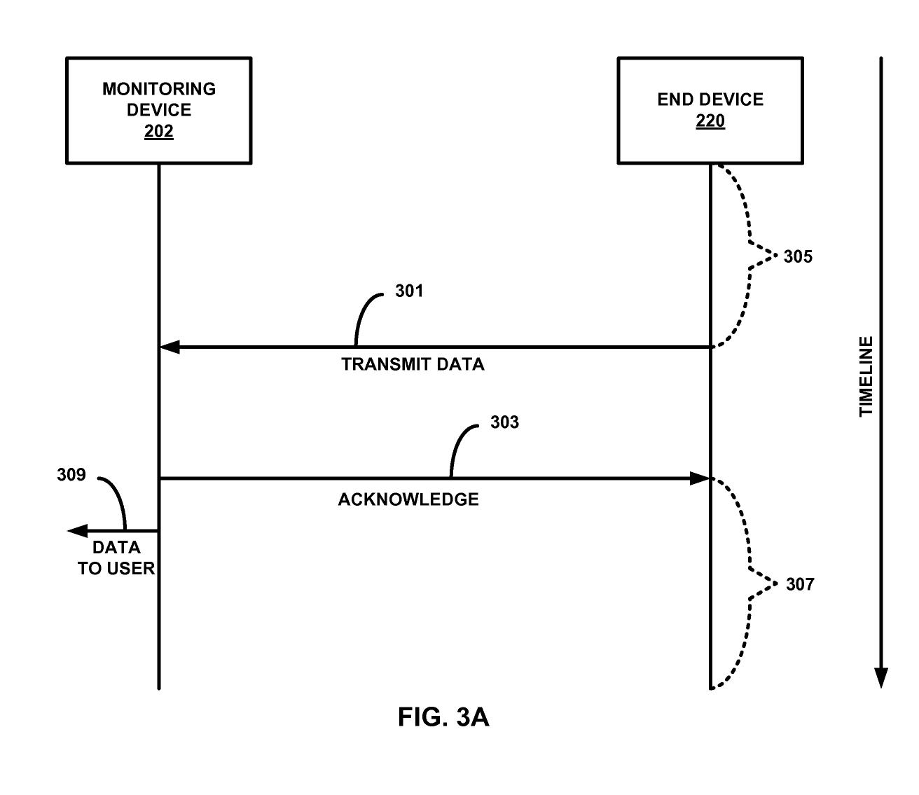

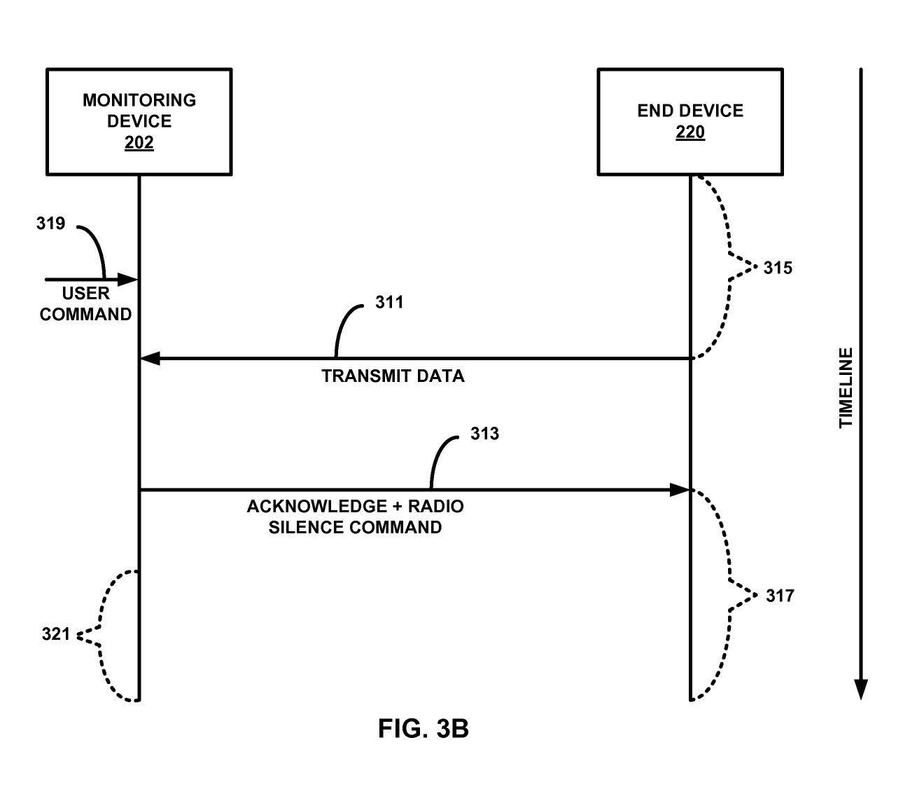

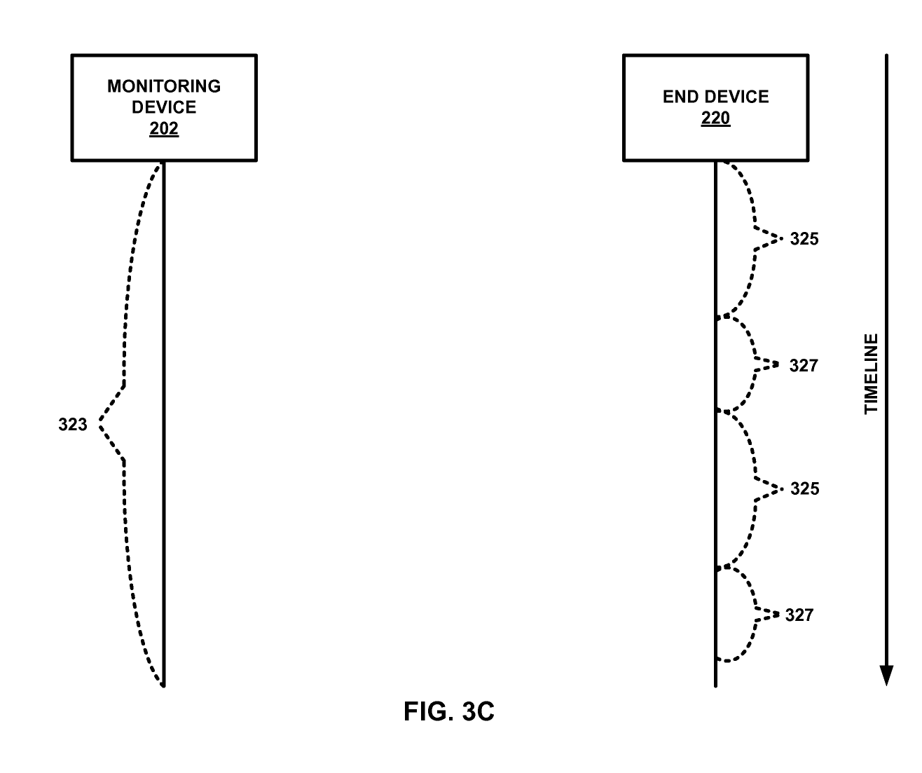

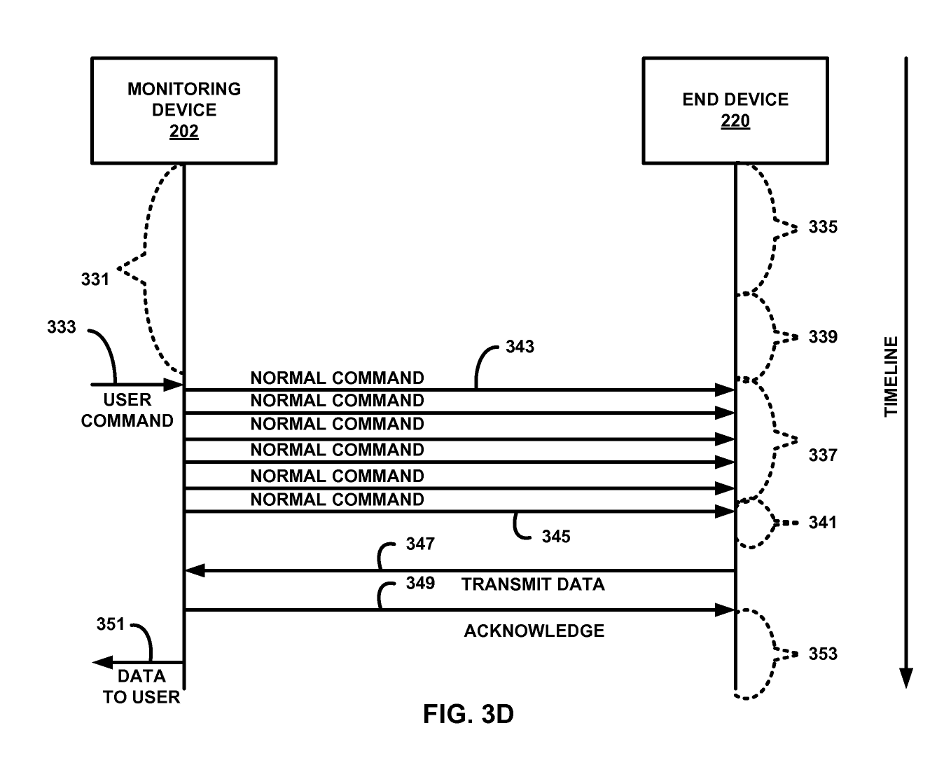

FIG. 3A illustrates an example timeline of operation of monitoring device 202 and end device 220 during normal operation mode. As FIG. 3A shows, end device 220 may be in sleep mode during a time 305. At the end of the sleep period 305, end device 220 may terminate sleep mode to perform the associated function and transmit data to monitoring device 202 indicating the performed function, as indicated by 301. Upon receiving the data from end device 220, monitoring device 202 may send an acknowledge signal 303 to end device 220. Upon receiving acknowledge signal 303, end device 220 may resume sleep mode 307 until the next time end device 220 needs to resume normal operation and transmit data to monitoring device 202. In one example, monitoring device 202 may send a signal 309 to a user with an indication of the data 301 received from end device 220.

An event (e.g., user input or a time/date change) may occur resulting in indicating to monitoring device 202 that a disabled end device mode (e.g., radio silence mode) should be the operating mode of the device in network 200. During that time, end device 220 may operate in sleep mode and may resume normal operation to transmit data to monitoring device 202. Upon receiving the data, monitoring device 202 may send an acknowledge signal to end device 220 along with a command signal to activate radio silence mode. Upon receiving the acknowledge signal and radio silence command from monitoring device 202, end device 220 may resume sleep mode and go into radio silence mode. Monitoring device 202 may send the radio silence mode command signal to all end devices 220 in network 200. The timing of when the command is sent to each of end devices 220 may depend on when each of end devices 220 transmits data to monitoring device 202. In one example, once all commands are transmitted to end devices 220 to activate radio silence mode, monitoring device 202 may itself operate in radio silence mode.

FIG. 3B illustrates an example timeline of operation of monitoring device 202 and end device 220 while changing from normal operating mode to radio silence mode. As FIG. 3B shows, monitoring device 202 and end device 220 may be operating in a normal operating mode associated with each device, respectively, until an event 319 occurs indicating that devices in network 200 should operate in radio silence mode. End device 220 may be operating in sleep mode during a time 315 and still operating in normal operating mode. At the end of the sleep period 315, end device 220 may resume normal operation (e.g., both its receiver and transmitter are activated), perform the associated function and transmit data to monitoring device 202 indicating the performed function, as indicated by 311. Upon receiving the data from end device 220, monitoring device 202 may send signal 313 to end device 220. Signal 313 may include an acknowledgement of the receipt of data 311 transmitted by end device 220. Additionally, signal 313 may also include a radio silence command signal indicating to end device 220 that it should operate in radio silence mode. Upon receiving signal 313, end device 220 may resume sleep (e.g., both its receiver and transmitter are inactive) and go into radio silence mode. After monitoring device 202 has sent out radio silence commands to all end devices 220 in network 200, monitoring device 202 may also operate in radio silence mode 321.

In one example, during radio silence mode, end devices 220 and monitoring device may turn off the transmitting capability of their respective RF transceivers. Turning off the transmitting capabilities in end devices 220 may result in significant reduction of the consumed power, as transmitting consumes a large amount of battery life. In this example, receiving capabilities of the RF transceivers may be enabled or on. In another example, to achieve greater reduction in the amount of power consumed by end devices 220, end devices 220 may operate in sleep mode, where each of the devices is completely off, and turns on periodically with the receiving on to look for commands or messages sent to end device 220. Therefore, in one example, operating in radio silence mode may involve alternating between operating in sleep mode where the receiver and transmitter are turned off, and operating in receive-only mode where the receiver is on and the transmitter is off

During radio silence mode, monitoring device 202 may continue operating in radio silence mode, where monitoring device 202 is neither transmitting nor receiving data/signals. Monitoring device 202 may operate in radio silence mode until an event occurs indicating radio silence mode should be suspended and normal operating mode should be resumed.

FIG. 3C illustrates an example timeline of operation of monitoring device 202 and end device 220 during radio silence mode. As FIG. 3C shows, while in radio silence mode, end device 220 may operate in sleep mode 325 during which end device 220 is turned off, or the receiver and transmitter of end device 220 are both off. Periodically, end device 220 may activate the receiver 327 of its RF transceiver to check for any commands directed to end device 220 from monitoring device 202. If end device 220 does not receive any commands during time 327, end device 220 resumes sleep (i.e., operate in the sleep mode), until a subsequent time 327 when end device 220 activates its receiver to look for a command signal from monitoring device 202. During radio silence mode, monitoring device continue operation in radio silence mode 323 until an event occurs indicating that radio silence mode should be terminated.

In one example, during radio silence mode, both end device 220 and monitoring device 202 may be operating in the sleep mode, and end device 220 may activate its receiver periodically to check for commands directed to it, e.g., from monitoring device 202. When end device 220 operates during radio silence mode, it activates its receiver, but may not need to activate its transmitter, as it will need the transmitter when it is operating in normal operating mode. If end device 220 does not receive any commands, it resumes operating in the sleep mode.

Monitoring device 202 may remain in radio silence mode until it receives a command indicating that radio silence mode should be suspended. In one example, a user may provide such a command by activating a switch or button to turn the network back on. In another example, the command to return to normal operating mode may be automatic and based on timing, e.g., termination of a predetermined downtime. When monitoring device 202 receives an input from a user (e.g., push of a switch) indicating a command to terminate radio silence mode, monitoring device 202 may resume normal operation and may begin transmitting signals to all end devices 220 in network 200, where the signal may include a command for each of end devices 220 to return to normal operating mode.

When end device 220 is operating in sleeping mode, both its transmitter and receiver are turned off, and therefore, end device 220 does not receive the signals transmitted by monitoring device 202. End device 220 may activate its receiver periodically to determine whether monitoring device 202 has sent a signal with a command to end device 220. Meanwhile, monitoring device may be transmitting a command signal to end device 220, where the command may indicate that end device 220 to return to normal operating mode. Therefore, next time end device 220 activates its receiver, end device 220 receives the signal from monitoring device 202 with the command to return to normal operating mode. End device 220 then returns to normal operating mode by activating both its receiver and transmitter. End device 220 then operates per its normal operation as described above, where it performs the associated functionality and transmits data to monitoring device 202 with data. In response, monitoring device 202 may transmit an acknowledge signal to end device 220, and may send an indication to the user of the data received from end device 220.

In one example, when each end device 220 receives the signal to return to normal operating mode and end device 220 returns to normal operating mode, end device 220 may transmit to monitoring device 202 a signal indicating that end device had returned to normal operating mode. Monitoring device 202 may keep track of the number of end devices 220 associated with monitoring device 202, and the number of end devices that have reverted to normal operating mode, and the number of end devices from which monitoring device 202 has not yet received signals indicating return to normal operating mode. If monitoring device 202 does not receive a signal indicating return to normal operating mode from an end device after an amount of time that exceeds a threshold time, e.g., 5 seconds, monitoring device 202 may add the end device to a list of unresponsive devices. In one example, the amount of time compared to the threshold time may be the time elapsed since the first signal with the command to return to normal operating mode was transmitted by monitoring device 202 to the end device.

In one example, monitoring device 202 may send an alert to a user indicating the number of end devices that have not responded with a signal indicating return to normal operating mode. In another example, monitoring device 202 may send an alert to the user indicating identifiers associated with end devices that have not responded with a signal indicating return to normal operating mode.

FIG. 3D illustrates an example timeline of operation of monitoring device 202 and end device 220 while returning from radio silence mode to normal operating mode. As FIG. 3D shows, end device 220 may be operating in radio silence mode, where it sleeps (or turns off its receiver and transmitter) for a period of time 335 and 337, then periodically wakes up (or activates its receiver) for a short period 339 to check for any signals transmitted to it.

Monitoring device 202 may be also in radio silence mode and sleeping for a period of time 331, until it receives an input from a user (e.g., push of a switch) indicating a command 333 to return to normal operating mode. Monitoring device 202 may as a result activate its receiver and transmitter, therefore terminating its disable monitoring device mode or sleep mode, and send out command signals 343 indicating to end devices 220 to return to normal operation mode. Command signals 343 transmitted by monitoring device 202 may not be received by end device 220 while end device 220 is operating in sleep period 337. At the next periodic wake up period 341 when end device 220 activates its receiver, end device 220 may receive the most recent command signal 345 from monitoring device 202. As a result, end device 220 resumes normal operating mode, by turning on its transmitter, and performs its normal functionality explained above in FIG. 3A, where end device 220 transmits data 347 to monitoring device 202 and receives acknowledge signal 349 from monitoring device. When monitoring device 202 receives data 347 from end device 220, monitoring device 202 transmits an acknowledge signal 349 to end device 220. Monitoring device 202 may also provide an indication 351 to the user of the data received from end device 220.

In one aspect of this disclosure, monitoring device 202 may utilize radio silence module 250 to determine the appropriate operating mode for end devices 220. In one example, the operating mode may be determined based on user input. The user input may be direct or indirect. For example, a user may determine that end devices 220 need to operate in radio silence mode because of existence of certain conditions (e.g., security issues, safety issues, and so forth). Subsequently, when the conditions necessitating the radio silence mode have ended or no longer exist, the user may indicate to monitoring device 202 to instruct end devices 220 to return to normal operating mode. In one example, the user may directly indicate to monitoring device 202 the desired operating mode of end devices 220 using an input device (e.g., switch, button, or the like). In one example, where a user may turn off monitoring device 202, monitoring device 202 may utilize a backup power source, e.g., a battery, to signal the radio silence mode to end devices 220 of network 200.

In another example, the user may indirectly indicate to monitoring device 202 the desired operating mode of end devices 220. For example, the operation mode may be determined based on a sensed condition and a predetermined corresponding operating mode. For example, monitoring device 202 may be configured to instruct end devices 220 to operate in radio silence mode during down time (e.g., after hours, during the weekend, during a specific maintenance period every day, and the like), where a user may configure down time settings in monitoring device 202. Likewise, monitoring device 202 may be configured to instruct end devices 220 to return to operating in normal mode when down time has expired, e.g., during operating hours, during the week, and so forth.

In one example, during down time (e.g., after hours, during the weekend, during a specific maintenance period every day, and the like), monitoring device 202 may send out command signals to all end devices 220 to go into a disabled end device mode or radio silence mode. After confirming that command signals have been transmitted to all end devices 220 in network 200 to operate in radio silence mode, monitoring device 202 may itself operate in a disabled monitoring device mode or radio silence mode, until the condition requiring the down time has expired.

In the example where a user input or command may be used to determine when to activate radio silence mode and when to resume normal operating mode, a user input or command indicating return to normal operating mode may cause monitoring device 202 to return to normal operating mode, then send enabling command signals to all end devices 220 to terminate the disabled end device mode and return to normal operating mode. In another example, where switching between modes is automatic and based on a sensed condition (e.g., environmental conditions, time of day, day of week, or the like), monitoring device 202 may automatically return to normal operating mode at the end of the specific time period during which radio silence mode or disabled device mode is observed, then send enabling command signals to all end devices 220 to resume normal operating mode.

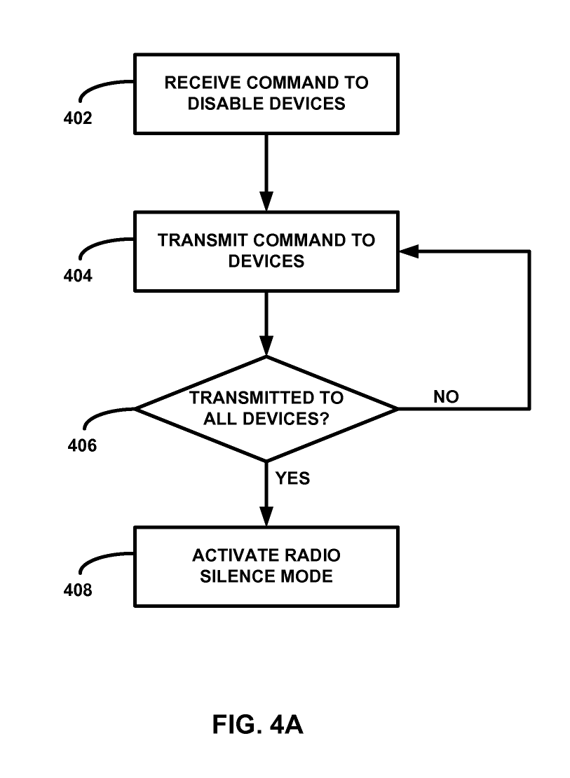

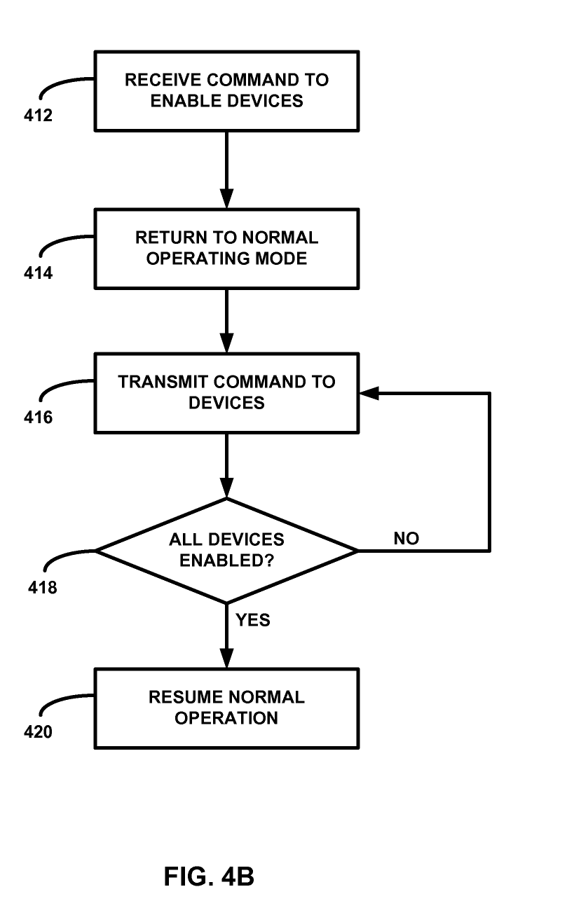

FIG. 4A is a flow chart of an example method for disabling devices in a wireless network, in accordance with techniques of this disclosure. The illustrated example method may be performed by wireless monitoring devices 102 and/or 202 (FIGS. 1 and 2). In some examples, a computer-readable storage medium (e.g., memory 204 of FIG. 2) may store instructions or modules (e.g., radio silence module 150 or 250) that, when executed, cause one or more processors (e.g., processor 208) to perform one or more of the acts illustrated in the methods described herein.

The method of FIG. 4A includes processor 208 of monitoring device 202 receiving a command to disable wireless end devices 220 of network 200 (402). The command may be provided directly or indirectly by a user. For example, a user may directly provide the command to monitoring device 202 by selecting a switch dedicated to disabling devices in network 200. In another example, the user may turn off the power supply to monitoring device 202, which may cause monitoring device 202 to revert to a backup power supply (e.g., battery) to effectuate disabling of all other devices in network 200 before monitoring device 202 is disabled. In yet another example, the user may configure monitoring device 202 to indicate conditions upon the occurrence of which devices in network 200 should be disabled. In this example, monitoring device 202 may sense when the configured conditions occur and execute an instruction to disable devices in network 200. The condition may be, for example, a sensed environmental condition (e.g., above or below a threshold temperature, humidity, amount of light, and the like), a certain time of day (e.g., after 5 p.m.), a certain day of week (e.g., a weekend), loss of power in the system, or some other condition or event sensed or determined by monitoring device 202.

Monitoring device 202 may then utilize transceiver 210 to transmit to end devices 220 a command signal indicating to go into a disabled end device mode (e.g., radio silence mode) (404). Monitoring device 202 may store (e.g., in memory 204) a list of all end devices 220 associated with network 200. As monitoring device 202 sends out the disabling command signal to end devices 220, monitoring device 202 may determine whether the disabling command signal has been transmitted to all end devices 220 (406). If not, monitoring device 202 may continue on transmitting the disabling command signal, until all end devices 220 receive the disabling command signal. When each of end devices 220 receives the disabling command signal from monitoring device 202, each of end devices 220 may operate in a disabled end device mode or radio silence mode.

In one example, during radio silence mode, end device 220 may operate in a receive-only mode, i.e., end device 220 turns off its transmitting capabilities. In another example, during silence mode, end device 220 may shut off completely or turn of both its receiving and transmitting capabilities, and periodically turn on its receiving capabilities for a short period to determine whether any device (e.g., monitoring device 202) has transmitted signals directed to end device 220. When all end devices 220 in network 200 are operating in disabled end device mode, monitoring device 202 may activate the disable monitoring device mode, i.e., operate in radio silence mode itself (408).

FIG. 4B is a flow chart of an example method for enabling devices in a wireless network, in accordance with techniques of this disclosure. As with FIG. 4A, the illustrated example method of FIG. 4B may be performed by monitoring devices 102 and/or 202. In some examples, a computer-readable storage medium (e.g., memory 204 of FIG. 2) may store instructions or modules (e.g., radio silence module 150 or 250) that, when executed, cause one or more processors (e.g., processor 208) to perform one or more of the acts illustrated in the methods described herein.

During the disabled mode, i.e., radio silence mode, end devices 220 may be operation either in receive-only mode or may shut off for a period of time and periodically turn on the receiving capability to determine whether monitoring device 202 has sent out a command to end device 220, as described above. During the disabled monitoring device mode, monitoring device 202 may be shut off or may be operating in a power-saving mode. While in the disabled monitoring device mode, processor 208 of monitoring device 202 may receive a command from a user to enable devices in network 200 (412). The command may be direct or indirect, as described above. For example, a user may switch monitoring device back on, if previously switched off. In another example, a condition necessitating disabling of devices in network 200 may no longer exist, and an indication to enable devices may be generated by processor 208.

Monitoring device 202 may then terminate the disabled monitoring device mode (414). Monitoring device 202 may then utilize transceiver 210 to transmit to end devices 220 an enabling command signal to terminate the disabled end device mode (e.g., suspend the radio silence mode) (416). Monitoring device 202 may store (e.g., in memory 204) a list of all end devices 220 associated with network 200. As monitoring device 202 sends out the termination of disabled end device mode command or enabling command signal to end devices 220, monitoring device 202 may determine whether the enabling command signal has been transmitted to all end devices 220 (418). If not, monitoring device 202 may continue on transmitting the enabling command signal, until all end devices 220 receive the enabling command signal. When each of end devices 220 has received from monitoring device 202 the enabling command signal indicating to end devices 220 to terminate the disabled end device mode, each end device 220 terminates the radio silence mode and resumes normal operating mode (420).

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer-readable medium, such as a computer-readable storage medium, containing instructions. Instructions embedded or encoded in a computer-readable medium, including a computer-readable storage medium, may cause one or more programmable processors, or other processors, to implement one or more of the techniques described herein, such as when instructions included or encoded in the computer-readable medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may comprise one or more computer-readable storage media.

In some examples, a computer-readable storage medium may comprise a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various embodiments of the invention have been described. These and other embodiments are within the scope of the following claims.

1. A method comprising:
receiving, by a wireless monitoring device associated with a wireless network comprising one or more wireless end devices, a first command to disable the one or more wireless end devices;
transmitting to the one or more wireless end devices a disabling command signal, wherein each of the one or more wireless end devices is caused to operate in a disabled end device mode upon receiving the disabling command signal, and wherein during the disabled end device mode each of the one or more wireless end devices shuts off and periodically turns on a receive-only mode to determine if there are any signals have been transmitted to it by other devices in the wireless network; and
activating a disabled monitoring device mode in the wireless monitoring device upon confirmation that each of the one or more wireless end devices is disabled.

2. A method comprising:
receiving, by a wireless monitoring device associated with a wireless network comprising one or more wireless end devices, a first command to disable the one or more wireless end devices;
transmitting to the one or more wireless end devices a disabling command signal, wherein each of the one or more wireless end devices is caused to operate in a disabled end device mode upon receiving the disabling command signal; and
activating a disabled monitoring device mode in the wireless monitoring device upon confirmation that each of the one or more wireless end devices is disabled.

3. The method of claim 2, wherein during the disabled end device mode each of the one or more wireless end devices operates in a receive-only mode.

4. The method of claim 2, wherein during the disabled end device mode each of the one or more wireless end devices shuts off and periodically turns on a receive-only mode to determine if there are any signals have been transmitted to it by other devices in the wireless network.

5. The method of claim 2, wherein the first command comprises one of a direct interaction between a user and the wireless monitoring device and an instruction in response to occurrence of a condition.

6. The method of claim 5, wherein the condition comprises one or more of an environmental condition, a timing condition, and a system condition.

7. The method of claim 2, wherein the first command comprises switching off a main power source of the wireless monitoring device, further comprising reverting to a backup power source.

8. The method of claim 2, further comprising:
receiving a second command to enable the one or more wireless end devices;
terminating the disabled monitoring device mode in the wireless monitoring device; and
transmitting to the one or more wireless end devices an enabling command signal, wherein each of the one or more wireless end devices terminates the disabled end device mode upon receiving the enabling command signal.

9. A wireless monitoring device associated with a wireless network comprising:
a processor to receive a first command to disable one or more wireless end devices, wherein the wireless network comprises the one or more wireless end devices; and
a transceiver to transmit to the one or more wireless end devices a disabling command signal, wherein each of the one or more wireless end devices goes into a disabled end device mode upon receiving the disabling command signal, and wherein the processor activates a disabled monitoring device mode in the wireless monitoring device upon confirmation that each of the one or more wireless end devices is disabled.

10. The wireless monitoring device of claim 9, wherein during the disabled end device mode each of the one or more wireless end devices operates in a receive-only mode.

11. The wireless monitoring device of claim 9, wherein during the disabled end device mode each of the one or more wireless end devices shuts off and periodically turns on a receive-only mode to determine if there are any signals have been transmitted to it by other devices.

12. The wireless monitoring device of claim 9, wherein the first command comprises one of a direct interaction between a user and the wireless monitoring device and an instruction in response to occurrence of a condition.

13. The wireless monitoring device of claim 9, further comprising:
a main power source; and
a backup power source, wherein the first command comprises switching off the main power source of the wireless monitoring device, and wherein the processor is configured to revert to the backup power source.

14. The wireless monitoring device of claim 9, wherein the processor receives a second command to enable the one or more wireless end devices, terminates the disabled monitoring device mode in the wireless monitoring device, and causes the transceiver to transmit to the one or more wireless end devices an enabling command signal, wherein each of the one or more wireless end devices terminates the disabled end device mode upon receiving the enabling command signal.

15. A computer-readable storage medium comprising instructions that, when executed, cause a processor of a wireless monitoring device to:
receive a first command to disable one or more wireless end devices, wherein the wireless monitoring device is associated with a wireless network comprising the one or more wireless end devices;
transmit to the one or more wireless end devices a disabling command signal, wherein each of the one or more wireless end devices goes into a disabled end device mode upon receiving the disabling command signal; and
activate the disabled monitoring device mode in the wireless monitoring device upon confirmation that each of the one or more wireless end devices is disabled.

16. The computer-readable storage medium of claim 15, wherein during the disabled end device mode each of the one or more wireless end devices operates in a receive-only mode.

17. The computer-readable storage medium of claim 15, wherein during the disabled end device mode each of the one or more wireless end devices shuts off and periodically turns on a receive-only mode to determine if there are any signals have been transmitted to it by other devices.

18. The computer-readable storage medium of claim 15, wherein the first command comprises one of a direct interaction between a user and the wireless monitoring device and an instruction in response to occurrence of a condition.

19. The computer-readable storage medium of claim 15, wherein the first command comprises switching off a main power source of the wireless monitoring device, further comprising instructions that cause the processor to revert to a backup power source.

20. The computer-readable storage medium of claim 15, further comprising instructions that cause the processor to:
receive a second command to enable the one or more wireless end devices;
terminate the disabled monitoring device mode in the wireless monitoring device; and
transmit to the one or more wireless end devices an enabling command signal, wherein each of the one or more wireless end devices terminates the disabled end device mode upon receiving the enabling command signal.
